(19) United States
(12) Patent Application Publication
(10) Pub. No.: US 2015/0261328 A1
(43) Pub. Date: Sep. 17, 2015

(54) COORDINATE DETECTION SYSTEM, INFORMATION PROCESSING DEVICE, AND RECORDING MEDIUM STORING COORDINATE DETECTION PROGRAM

(71) Applicant: Hiroyuki NAGANO, Tokyo (JP)

(72) Inventor: Hiroyuki NAGANO, Tokyo (JP)

(73) Assignee: RICOH COMPANY, LTD., Tokyo (JP)

(21) Appl. No.: 14/658,400

(22) Filed: Mar. 16, 2015

(30) Foreign Application Priority Data
Mar. 17, 2014 (JP) 2014-053780

(51) Int. Cl. G06F 3/0354; G06F 3/03

(52) U.S. Cl. CPC G06F 3/03545; G06F 3/0325

(57) ABSTRACT

A coordinate detection system, an information processing device, and a non-transitory recording medium storing a coordinate detection program are provided. The coordinate detection system includes an indicator configured to emit an optical signal on a board, at least three photosensors configured to receive the optical signal emitted from the indicator, a detector configured to detect position coordinates of the indicator based on the optical signal received from the indicator, a switching unit configured to switch between a first mode and a second mode, and a controller configured to control an amount of light emission of the indicator according to the first or second mode switched by the switching unit. The coordinate detection program causes the information processing device to execute a method including detecting position coordinates, switching between a first mode and a second mode, and controlling an amount of light emission.

### CROSS-REFERENCE TO RELATED APPLICATION

This patent application is based on and claims priority pursuant to 35 U.S.C. §119(a) to Japanese Patent Application No. 2014-053780, filed on Mar. 17, 2014, in the Japan Patent Office, the entire disclosure of which is hereby incorporated by reference herein.

### BACKGROUND

1. Technical Field

Example embodiments of the present invention relate to a coordinate detection system, an information processing device, and a non-transitory recording medium storing a coordinate detection program.

2. Background Art

Electronic whiteboards, i.e., digitized whiteboards that are used in conference rooms, are known. As a method of realizing such electronic whiteboards, a method in which a touch panel is used or a method in which the light emitted from a light-emitting electronic stylus is detected by sensors arranged on the periphery of an electronic whiteboard are known.

### SUMMARY

Embodiments of the present invention described herein provide a coordinate detection system, an information processing device, and a non-transitory recording medium storing a coordinate detection program. The coordinate detection system includes an indicator configured to emit an optical signal on a board, at least three photosensors arranged on a periphery of the board and each configured to receive the optical signal emitted from the indicator, a detector configured to detect position coordinates of the indicator based on the optical signal received from the indicator a switching unit configured to switch between a first mode in which the position coordinates of the indicator are detected based on the optical signal received by the at least three photosensors and a second mode in which the position coordinates of the indicator are detected based on the optical signal received by two of the at least three photosensors, and a controller configured to control an amount of light emission of the indicator according to the first or second mode switched by the switching unit. The information processing device includes the detector, the switching unit, and the controller. The coordinate detection program causes a computer to execute a method including detecting position coordinates of the indicator based on the optical signal received from the indicator, switching between a first mode in which the position coordinates of the indicator are detected based on the optical signal received by the at least three photosensors and a second mode in which the position coordinates of the indicator are detected based on the optical signal received by two of the at least three photosensors, and controlling an amount of light emission of the indicator according to the first or second mode switched by the switching.

### BRIEF DESCRIPTION OF THE SEVERAL VIEWS OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a diagram of the system configuration of a coordinate detection system according to an example embodiment of the present invention.

FIG. 2 is a block diagram illustrating an example of the hardware configuration of a computer of FIG. 1, according to an example embodiment of the present invention.

FIGS. 3A and 3B are a flowchart of processes according to an example embodiment of the present invention.

FIG. 4 illustrates the relationship between position coordinates and sensors in use in a method in which only two sensors are used, according to an example embodiment of the present invention.

FIG. 5 illustrates the relationship between an electronic stylus and sensors when the communication between the electronic stylus and one of the sensors is interrupted by a hand, according to an example embodiment of the present invention.

FIG. 6 illustrates the relationship between position coordinates and sensors in use in a method in which only two sensors are used, according to a modification of an example embodiment.

FIG. 7 depicts the sequence of operation that leads to a mode in which only two sensors are used, according to an example embodiment of the present invention.

FIG. 8 depicts the sequence of operation that leads to a mode in which all the sensors are used, according to an example embodiment of the present invention.

FIG. 9 depicts the sequence of operation performed when two sensors have failed to obtain coordinate data, according to an example embodiment of the present invention.

FIG. 10 depicts the sequence of operation performed when two sensors start obtaining coordinate data again, according to an example embodiment of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific-integrated-circuits (ASICs), field programmable gate arrays (FPGAs) computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

According to one aspect of the present invention, power saving of an electronic stylus used for electronic whiteboards is achieved as follows. The combinations of two sensors that are used for detecting the coordinates on the electronic whiteboard are determined in advance, and the sensors are switched according to the determined combinations as necessary when drawing is performed. Accordingly, it becomes no longer necessary for the electronic stylus to emit the light up to the amount that satisfies the detection levels of all the sensors provided for the electronic whiteboard, and the electronic stylus can operate with a minimum amount of light emission.

In known method where a light-emitting electronic stylus is used, the light emitted from an electronic stylus is sensed by a plurality of sensors provided for an electronic whiteboard, and the coordinates of the electronic stylus are calculated by performing triangulation. For this reason, an electronic stylus is designed to emit the light up to the amount that enables all the sensors to sense the position of the electronic stylus accurately wherever on the electronic whiteboard the electronic stylus is positioned. For example, when an electronic whiteboard is rectangular and provided with four sensors at the four corners, an electronic stylus is designed to emit the light up to the amount that enables all the sensors to sense the position of the electronic stylus accurately even when the electronic stylus is positioned at one of the corners and the distance between the electronic stylus and the sensor is maximum across the diagonal line.

However, in triangulation, it is possible to calculate the coordinates of an electronic stylus with the information from two sensors. One reason for the provision of three or more sensors is to deal with cases in which a hand of an operator touching the electronic whiteboard while performing drawing interrupts the light between some of the sensors and the electronic stylus. By providing three or more sensors, the position coordinates of the electronic stylus can be obtained based on the information given from other sensors whose communication with the electronic stylus is not interrupted.

For users who never touch the electronic whiteboard by hand while performing drawing, the operation of just two sensors is sufficient and the amount of the light emission from an electronic stylus may be set to a low level as long as the two operating sensors can detect the position of the electronic stylus accurately. Accordingly, the use of more than three sensors is not necessary, and the amounts of the light emission that enables all the sensors to accurately detect the position of the electronic stylus is not necessary.

Moreover, there may be some users who would like to achieve power saving by trying not to touch the whiteboard, even though it is easier to perform drawing when his/her free hand is placed on the whiteboard. By so doing, the electronic whiteboard and electronic stylus can be used for a longer time.

As described above, in an example embodiment of the present invention, a light-emitting electronic stylus and an electronic whiteboard with a plurality of sensors are used. Further, the combinations of two sensors that are used for detecting the coordinates on the electronic whiteboard are determined in advance according to the position where drawing is being performed, and the detection sensors are switched according to the determined combinations as necessary. Accordingly, the electronic stylus can operate with a minimum amount of light emission, and the power saving of the electronic stylus can also be achieved.

Example embodiments of the present invention are described below in detail with reference to the drawings.

<System Configuration>

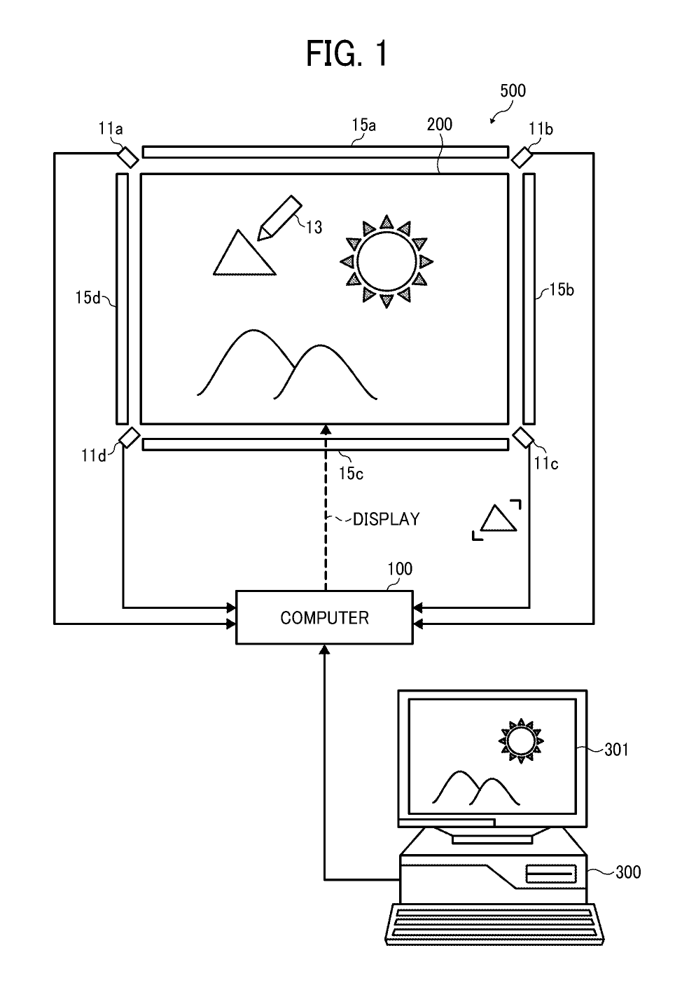

FIG. 1 is a diagram of the system configuration of a coordinate detection system according to the present example embodiment.

A coordinate detection system 500 illustrated in FIG. 1 includes a display 200, four sensors 11a to 11d (they may be referred to simply as the sensors 11), a computer 100, and an auxiliary personal computer (PC) 300. Note that four peripheral light-emitting units 15a to 15d are illustrated in FIG. 1, but are not described in detail because they are not essential elements in the example embodiment of the present invention.

The PC 300 is connected to the computer 100, and the computer 100 can display the image output from the PC 300 on the display 200. A coordinate detection application designed for the coordinate detection system is installed in the computer 100, and the application detects the position at which a user performed operation, based on the signals sent from the sensors. The application analyzes the gesture based on the detected position, and controls the computer 100. The application may display a menu for operation on the display 200.

For example, when a user touches the menu to select line drawing and draws a figure on the display 200 by using the indicator 13 such as an electronic stylus with light-emitting unit, the computer 100 analyzes the position at which the indicator 13 is touching in real time based on the light emitted from the light-emitting unit of the indicator 13, and generates time-series coordinates. The computer 100 generates a line by combining the time-series coordinates, and displays the generated line on the display 200. In FIG. 1, a user moved the indicator 13 along the shape of triangle. Accordingly, the computer 100 records the series of coordinates as a stroke (i.e., triangle). Then, the computer 100 superimposes the recorded stroke on top of the image obtained from the PC 300, and displays the resultant image on the display 200.

As described above, although the display 200 is not provided with touch panel function, a user can perform various kinds of operation with the coordinate detection system by touching the display 200 with the indicator 13.

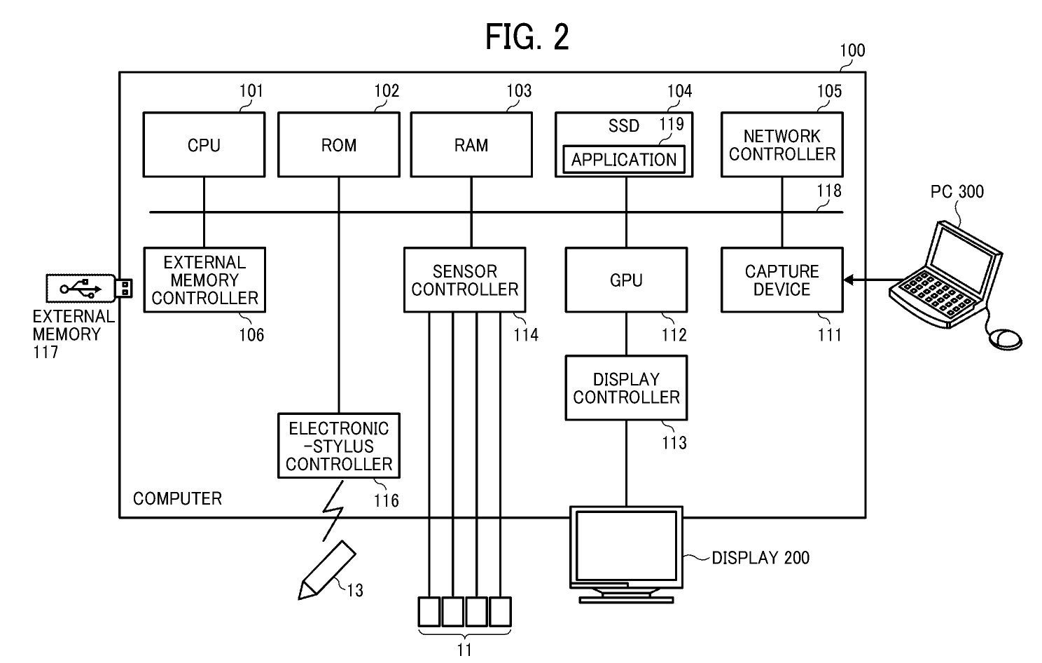

FIG. 2 is a block diagram illustrating an example of the hardware configuration of the computer 100, according to the present example embodiment.

The computer 100 may be a commercially available information processing device or an information processing device developed specifically for a coordinate detection system.

The computer 100 includes a CPU 101, a read only memory (ROM) 102, a random access memory (RAM) 103, a solid state disk (SSD) 104, a network controller 105, an external memory controller 106, a sensor controller 114, a graphics processing unit (GPU) 112, a capture device 111, a display controller 113, and an electronic-stylus controller 116, which are electrically connected to each other through a bus line 118 such as an address bus or data bus.

The CPU 101 executes an application to control the entire operation of the coordinate detection system 500. The ROM 102 stores information processing language (IPL) or the like, and a program to be executed mainly at the time of startup by the CPU 101. The RAM 103 serves as a working area in which the CPU 101 executes an application. The SSD 104 is a nonvolatile memory in which an application 119 for the coordinate detection system and other various kinds of data are stored. The network controller 105 performs processes that are based on a communications protocol when the computer 100 communicates with a server or the like through the network. The network is a wide area network (WAN) (e.g., the Internet) to which a single local area network (LAN) or multiple LANs are connected.

The external memory controller 106 writes data on a detachable external memory 117, or reads data from the detachable external memory 117. The external memory 117 may be, for example, a universal serial bus (USB) flash memory and a secure digital (SD) card. The capture device 111 captures the image displayed by the PC 300 on a monitor 301. The GPU 112 is a processor dedicated to drawing, and calculates the pixel value of each pixel of the display 200. The display controller 113 outputs the image generated by the GPU 112 to the display 200.

The sensor controller 114 is connected to the four sensors 11a to 11d, and detects the coordinates by performing triangulation based on the light emitted from the light-emitting unit of the indicator 13. In other words, the group of sensors 11 serves as photosensors, and the sensor controller 114 serves as a detector. In the present example embodiment, the sensor controller 114 is configured as a hardware device dedicated to specify coordinates by performing triangulation. However, no limitation is indicated herein, and the sensor controller 114 may be configured as software where the CPU 101 performs triangulation to specify coordinates.

The computer 100 is provided with communication capability with the indicator 13. Such communication capability may be realized by short-range radio communication such as Bluetooth (registered trademark).

The application designed for the coordinate detection system may be distributed upon being stored in the external memory 117, or may be downloaded from a server through the network controller 105. The application may be in a compressed format or in an executable format.

<Method of Detecting Position of Indicator>

In the present example embodiment, a method in which three or more of the sensors 11 are used (first method) or a method in which only two of the sensors 11 are used (second method) is used to detect the coordinates of the position from which light is emitted by the indicator 13 of FIG. 1 such as an electronic stylus. In the first method, any number of sensors may be used to improve the accuracy of the detection of position as long as at least three sensors are used. However, in the example embodiment described below, it is assumed that all the four sensors 11 are used to detect the position in the first method.

The two methods described above may be switched by the CPU 101 as necessary, such that the CPU 101 functions as a switching unit. The second method has an advantage over the first method in view of power saving. However, as will be described later with reference to FIG. 5, the second method may become disadvantageous when the detection ends in failure due to, for example, obstruction by hand. For this reason, accurate and power-saving position detection is achieved by switching the two methods as necessary, as in the present example embodiment described herein. Note that an event that triggers switching to the other method includes various types of situation, for example, a situation in which the coordinates of the indicator 13 were not detected due to obstruction by hand.

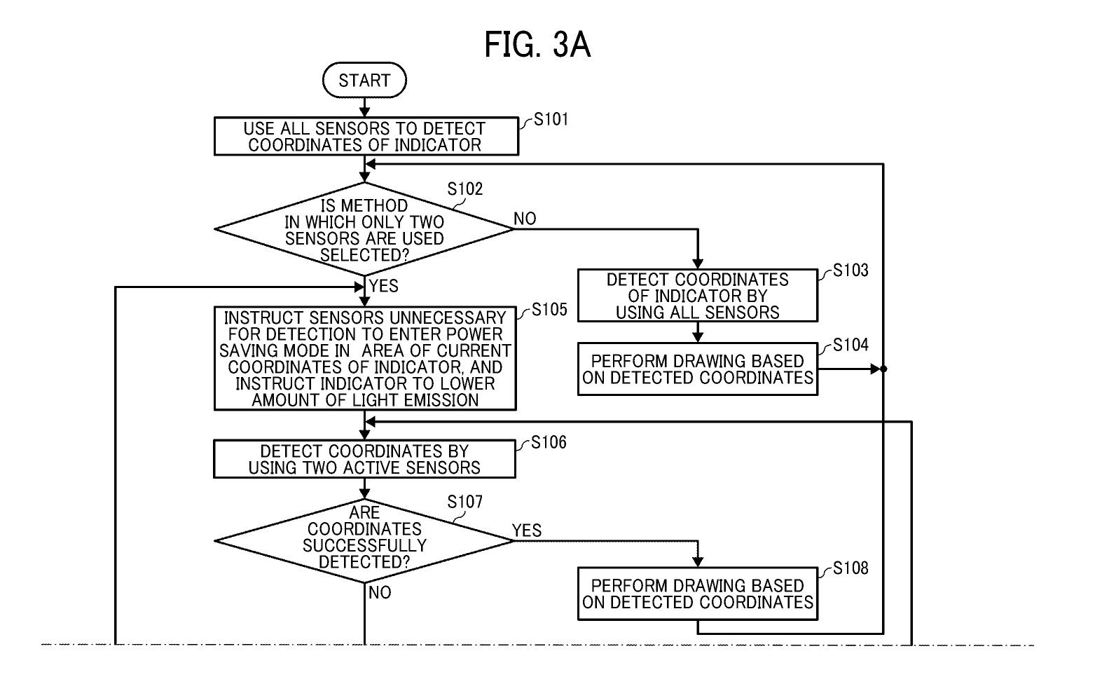

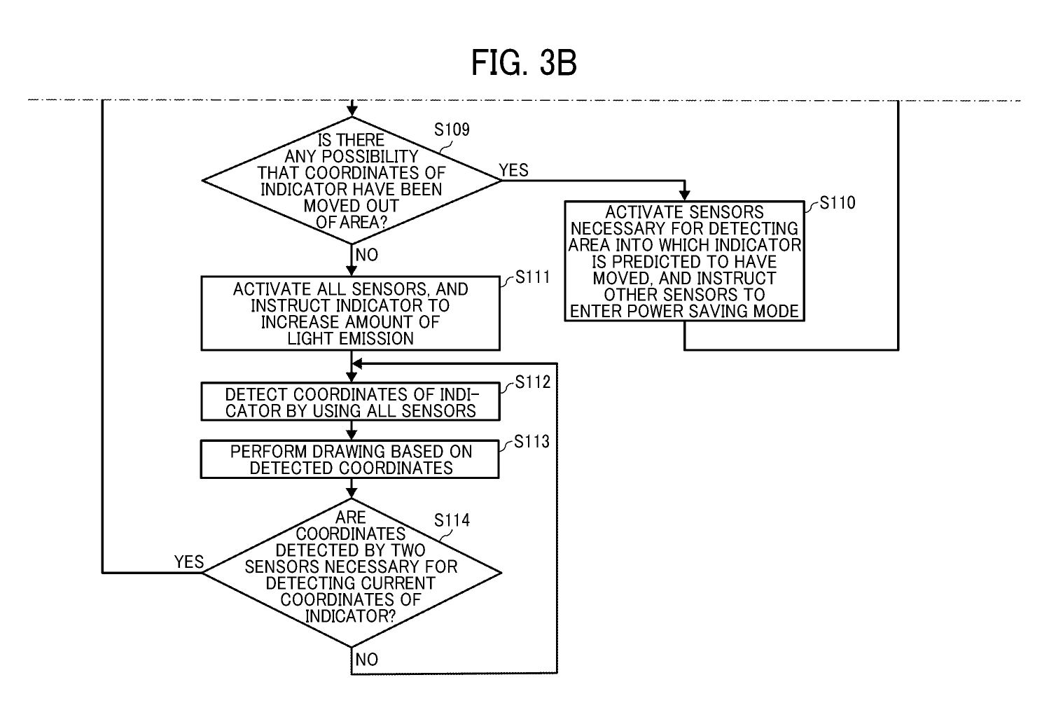

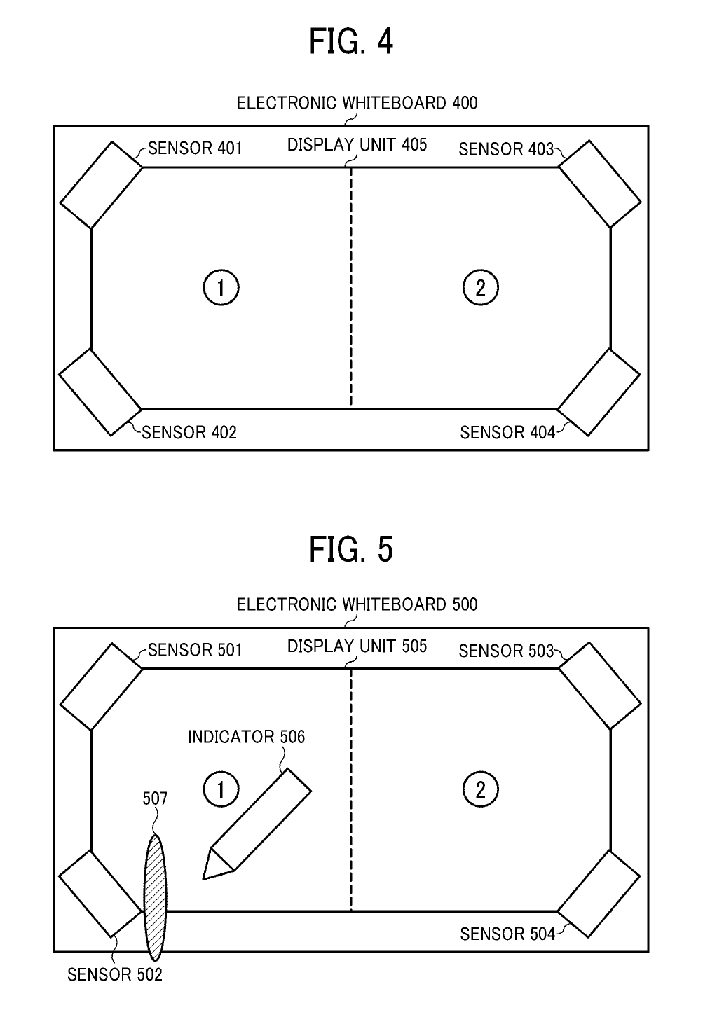

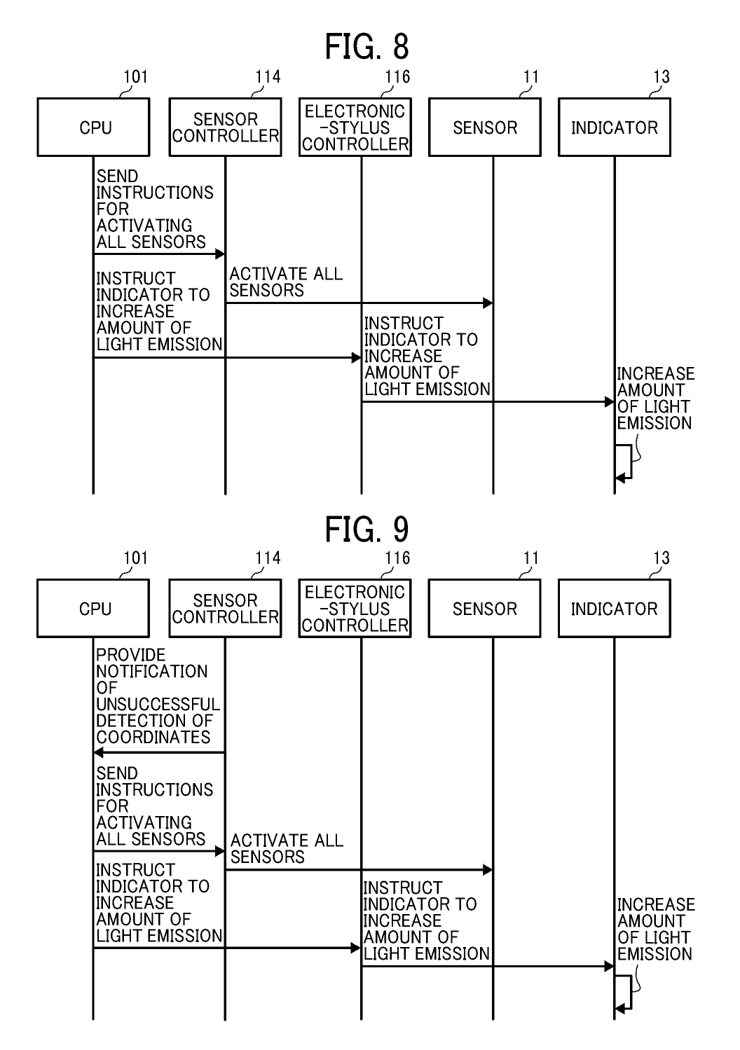

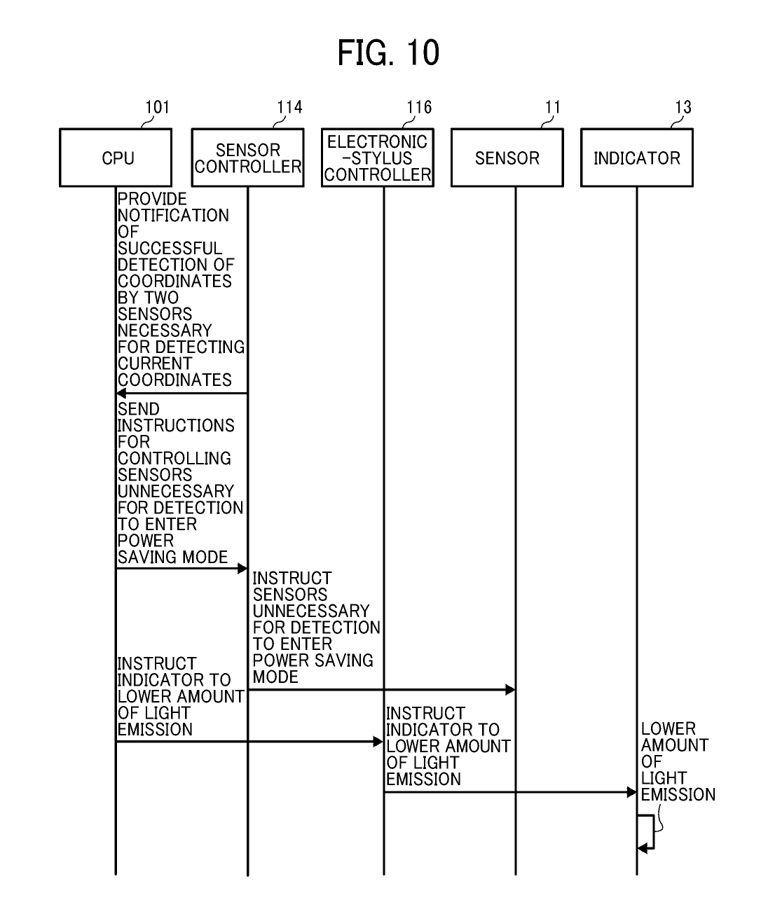

FIGS. 3A and 3B are a flowchart of the processes according to the present example embodiment. FIG. 4 to FIG. 6 illustrate detection according to the second mode of the present example embodiment. FIG. 7 depicts the sequence of operation that leads to a mode in which only two sensors are used, according to the present example embodiment. FIG. 8 depicts the sequence of operation that leads to a mode in which all the sensors are used, according to the present example embodiment. FIG. 9 depicts the sequence of operation performed when two sensors have failed to obtain coordinate data in a method in which only two sensors are used, according to the present example embodiment. FIG. 10 depicts the sequence of operation performed when two sensors start obtaining coordinate data again in a method in which only two sensors are used, according to the present example embodiment.

In the present example embodiment, as illustrated in FIG. 3, firstly, all the sensors 11 are used to detect the coordinates of the indicator 13 (S101). Next, the CPU 101 determines whether or not the method in which only two sensors are used is selected in the setting of detection method (S102). This selection is performed by manipulating a parameter that is set as desired by a user. When the method in which only two of the sensors 11 are used is not selected (“NO” in S102), the coordinates of the indicator 13 is detected by using all the sensors 11 (S103), and drawing is performed based on the detected coordinates (S104).

On the other hand, when the method in which only two of the sensors 11 are used is selected (“YES” in S102), the CPU 11 instructs the sensors 11 unnecessary for detection to enter a power saving mode in the area of the current coordinates of the indicator 13, and instructs the indicator 13 to lower the amount of light emission (S105). Then, the coordinates are detected by using the two active sensors 11 (S106). The relationship between the coordinates and the corresponding two sensors 11 will be described later with reference to FIG. 4.

When the coordinates are successfully detected by the method in which only two of the sensors 11 are used (S107), drawing is performed based on the detected coordinates (S108). After that, the setting may be checked again (S102). When the coordinates are not successfully detected, the process shifts to S109. Cases in which the coordinates cannot successfully be detected, for example, due to obstruction by hand, will be described later with reference to FIG. 5.

Whether there is a possibility that the coordinates of the indicator 13 have been moved out of the area is determined in S109. When it is determined that there is a possibility that the coordinates of the indicator 13 have been moved out of the area (“YES” in S109), the CPU 101 activates the sensors 11 necessary for detecting an area into which the indicator 13 is predicted to have moved, and instructs the other sensors 11 to enter a power saving mode (S110). Then, the coordinates are continuously detected by using the method in which only two of the sensors 11 are used (S106).

On the other hand, when it is determined that there is no possibility that the coordinates of the indicator 13 have been moved out of the area (“NO” in S109), the CPU 101 activates all the sensors 11 and instructs the indicator to increase the amount of light emission (S111), and the coordinates of the indicator 13 are detected by using the all sensors 11 (S112). Drawing is performed based on the detected coordinates (S113), and it is determined whether or not the coordinates are detected by the two sensors 11 necessary for detecting the detected coordinates (S114).

When the coordinates are detected by the two sensors 11 (“YES” in S114), the two sensors 11 continues detecting the coordinates (S105). When the coordinates are not detected by the two sensors 11 (“NO” in S114), the method in which the coordinates of the indicator 13 are detected by using the all sensors 11 is continuously used (S112).

<Switching of Position Detection Method>

The flowchart of the operation described above with reference to FIGS. 3A and 3B is further described with reference to FIG. 4 to FIG. 6. The numbers in circles as illustrated in FIG. 4 to FIG. 6 are referred to as (1), (2), (3), . . . , (n) with parentheses in the following description.

When the method in which only two sensors are used is used, such two sensors used for detection are determined in advance according to the position coordinates. For the purpose of simplification, in the present example embodiment, two sensors used for detection are determined according to the position coordinates as below, as illustrated in FIG. 4.

FIG. 4 illustrates the relationship between position coordinates and sensors in use in the method in which only two sensors are used, according to the present example embodiment.

As illustrated in FIG. 4, an electronic whiteboard 400 is provided with a display unit 405, and four sensors 401, 402, 403, and 404 at the four corners. The sensor 401 and the sensor 402 are used in the area (1) on the left side of the display unit 405 of FIG. 4, and the sensor 403 and the sensor 404 are used in the area (2) on the right side of the display unit 405.

In the present example embodiment, the four sensors are arranged at the four corner, and the area is equally divided into two. However, no limitation is indicated herein, and the area may be divided in various different ways depending on the number arrangement of sensors.

The method in which only two sensors are used may be selected by the following ways. For example, a switching user interface (UI) is displayed on the display unit 200, and when the indicator 13 touches the coordinates of the switching UI, the CPU 101 is notified of the switching of the mode. Alternatively, the indicator 13 is provided with a switch, and when switching is performed with the switch, the CPU 101 is notified of the switching of the mode from the indicator 13 through the electronic-stylus controller 116.

When power is turned on or when the mode is switched, the sensor controller 114 senses the coordinates of the indicator 13 based on the inputs from the four sensors 11. The CPU 101 detects at which of the prescribed areas the indicator is placed, and instructs the sensors 11 unnecessary for detection at the current coordinates to enter a power saving mode, through the sensor controller 114. In the power saving mode, the power or the clock is cutoff. Moreover, the CPU 101 instructs the indicator 13 to switch the amount of light emission through the electronic-stylus controller 116.

For example, when the firstly-detected coordinates are found to be within the area (1) of FIG. 4, the sensor 401 and the sensor 402 are used to detect the coordinates of the indicator 13, and the sensor 403 and the sensor 404 enter the power saving mode. Moreover, the amount of light emission with which the sensor 403 and the sensor 404 can sense the indicator 13 is no longer needed. Accordingly, the amount of light emission of the indicator 13 is reduced to the minimum amount of light emission with which the sensor 401 and the sensor 402 can sense the indicator 13 while the indicator 13 is located within the area (1).

Cases in which the drawing position moves across the prescribed areas may be dealt with by the following ways. For example, the motion vector of the indicator 13 is recorded in addition to the coordinates of the indicator 13 detected by the sensor controller 114. By so doing, when the signals from the two sensors 11 cease, the area to which the indicator 13 has moved can be estimated by the position coordinates and vector obtained immediately before the signals cease, and the sensors 11 used for detecting the coordinates of the indicator 13 are switched through the sensor controller 114 according to the estimated area. Alternatively, the coordinates of the indicator 13 may be updated by operating all the sensors at regular intervals.

The operation performed to deal with cases in which the interruption by a hand ceases the output from the sensors in operation while drawing is being performed in the method in which only two sensors are used is described with reference to FIG. 5.

FIG. 5 illustrates the relationship between an electronic stylus and sensors when the communication between the electronic stylus and one of the sensors is interrupted by a hand, according to an example embodiment of the present invention.

As illustrated in FIG. 5, an electronic whiteboard 500 includes sensors 501 to 504, a display unit 505, and an indicator 506. Moreover, a hand 507 is indicated in FIG. 5. Note that two sensors of FIG. 5 used for detection are also determined according to the position coordinates, in a similar manner to the operation described above with reference to FIG. 4.

For example, when the position coordinates indicated by the indicator 506 are within the area (1), the sensor 501 and the sensor 502 are in operation. When the hand 507 touches the display unit 505 and interrupts the communication between the indicator 506 and the sensor 502 under such circumstances as above, the coordinate data is no longer output from the sensor 502 and the detection of the position coordinates is disabled.

The subsequent operation is described with reference to FIG. 2. The sensor controller 114 notifies the CPU 101 of the fact that the coordinate data is no longer output from the sensor 11. Upon receiving the notification, the CPU 101 activates all the sensors 501 to 504 and instructs the indicator 13 to switch the amount of light emission through the electronic-stylus controller 116. The indicator 13 increases the amount of light emission such that all the sensors can sense the indicator 13 regardless of the coordinates at which the indicator 13 is placed.

Under the circumstance as illustrated in FIG. 5, the sensor controller 114 obtains the position coordinates of the indicator 13 according to the coordinate data output from the sensor 501, the sensor 503, and the sensor 504. When the hand 507 is detached from the display unit 505 and the sensor 502 starts outputting coordinate data, the sensor controller 114 notifies the CPU 11 of the updated situation, and the mode is switched again to the method in which only two sensors are used.

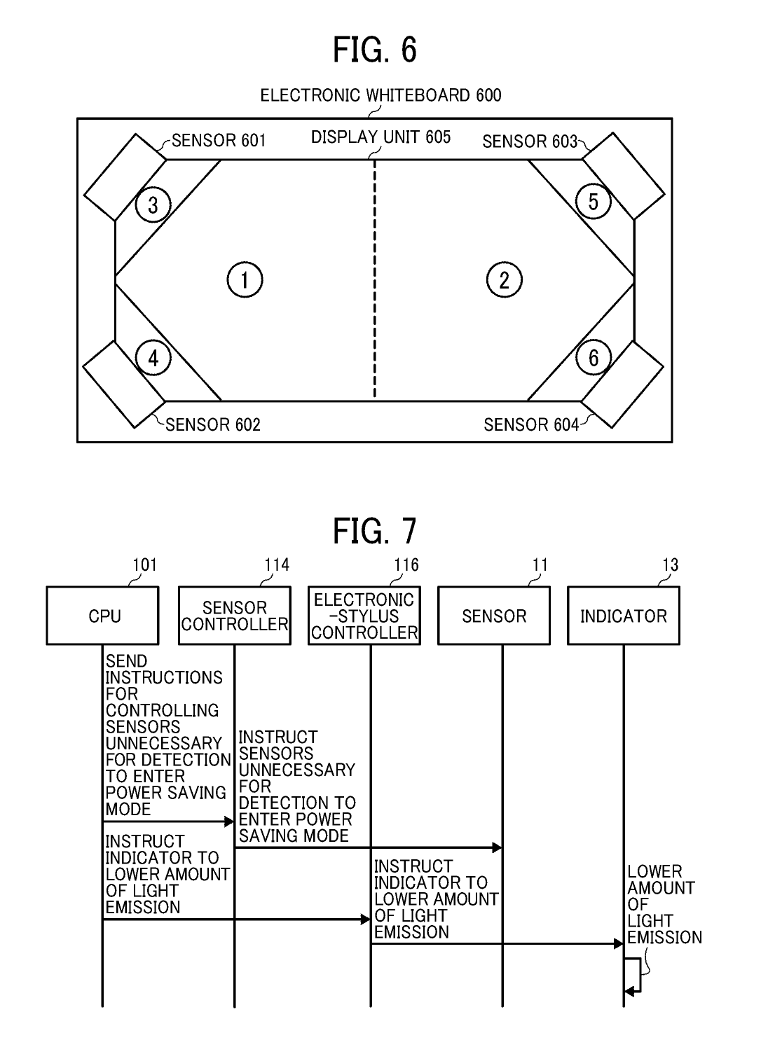

When the method in which only two sensors are used is used, such two sensors used for detection are determined in advance according to the position coordinates. The combinations of such two sensors may be determined as follows. For example, the two sensors that are first and second closest to the position coordinates of the indicator may be used. Alternatively, the sensor that is positioned within prescribed distance from the position coordinates of the indicator may be excluded, and the two sensors that are first and second closest to the position coordinates of the indicator among the remaining sensors may be used. This method is adopted in cases where the light quantity received at the sensor is saturated as the sensor is too close to the position coordinates of the indicator. In such cases, the coordinate position of the indicator cannot appropriately be detected. Such methods are described below with reference to FIG. 6.

FIG. 6 illustrates the relationship between position coordinates and sensors in use in the method in which only two sensors are used, according to a modification of the example embodiment described above.

As illustrated in FIG. 6, an electronic whiteboard 600 includes sensors 601 to 604 and a display unit 605. In an area (3) of FIG. 6, the sensor 601 is not used but the sensor 602 and the sensor 603 are used. In an area (4) of FIG. 6, the sensor 602 is not used but the sensor 601 and the sensor 604 are used. In an area (5) of FIG. 6, the sensor 603 is not used but the sensor 604 and the sensor 601 are used. In an area (6), the sensor 604 is not used but the sensor 603 and the sensor 602 are used.

According to the example embodiments described above, the combinations of two sensors that are used for detecting the coordinates on the electronic whiteboard are determined in advance, and the sensors are switched according to the determined combinations as necessary when drawing is performed. Accordingly, it becomes no longer necessary for the electronic stylus to emit the light up to the amount that satisfies the detection levels of all the sensors provided for the electronic whiteboard, and the electronic stylus can operate with a minimum amount of light emission. In other words, the power saving of the electronic stylus is achieved, and the electronic stylus can be used for a longer time.

Note that the hardware configuration illustrated in FIG. 1 and FIG. 2 is merely given as an example embodiment of the present invention, and no limitation is indicated therein. For example, an electronic whiteboard system where the electronic whiteboard 200 and the computer 100 as illustrated in FIG. 1 may be physically separate from each other is included in the scope of the present invention.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM, etc. Alternatively, any one of the above-described and other methods of the present invention may be implemented by ASICs, prepared by interconnecting an appropriate network of conventional component circuits, or by a combination thereof with one or more conventional general-purpose microprocessors and/or signal processors programmed accordingly.

What is claimed is:

1. A coordinate detection system comprising:
an indicator configured to emit an optical signal on a board;
at least three photosensors arranged on a periphery of the board and each configured to receive the optical signal emitted from the indicator;
a detector configured to detect position coordinates of the indicator based on the optical signal received from the indicator;
a switching unit configured to switch between a first mode in which the position coordinates of the indicator are detected based on the optical signal received by the at least three photosensors and a second mode in which the position coordinates of the indicator are detected based on the optical signal received by two of the at least three photosensors; and
a controller configured to control an amount of light emission of the indicator according to the first or second mode switched by the switching unit.

2. The coordinate detection system according to claim 1, wherein when the position coordinates of the indicator become no longer detectable by the two of the at least three photosensors in the second mode, the switching unit switches the second mode to the first mode and the controller increases the amount of light emission of the indicator.

3. The coordinate detection system according to claim 2, wherein when the position coordinates of the indicator become detectable as the second mode is switched to the first mode, the switching unit switches the first mode to the second mode and the controller reduces the amount of light emission of the indicator.

4. The coordinate detection system according to claim 1, wherein when the first mode is switched to the second mode, the switching unit selects two of the at least three photosensors that correspond to the detected position coordinates of the indicator, as the two of the at least three photosensors used in the second mode.

5. The coordinate detection system according to claim 4, wherein in the second mode, the two photosensors that correspond to the detected position coordinates of the indicator are first and second closest to the position coordinates of the indicator.

6. The coordinate detection system according to claim 5, wherein in the second mode, the first and second closest to the position coordinates of the indicator are other than one of the at least three photosensors that is positioned within prescribed distance from the position coordinates of the indicator.

7. The coordinate detection system according to claim 1, wherein in the second mode, the detector turns off a power of at least one of the photosensors that is not used for detecting the position coordinates of the indicator.

8. An information processing device comprising:
a detector configured to detect position coordinates of an indicator that emits an optical signal on a board, based on the optical signal received from the indicator;
a switching unit configured to switch between a first mode in which the position coordinates of the indicator are detected based on the optical signal received by at least three photosensors arranged on a periphery of the board and a second mode in which the position coordinates of the indicator are detected based on the optical signal received by two of the at least three photosensors; and
a controller configured to control an amount of light emission of the indicator according to the first or second mode switched by the switching unit.

9. The information processing device according to claim 8, wherein when the position coordinates of the indicator become no longer detectable by the two of the at least three photosensors in the second mode, the switching unit switches the second mode to the first mode and the controller increases the amount of light emission of the indicator.

10. The information processing device according to claim 9, wherein when the position coordinates of the indicator become detectable as the second mode is switched to the first mode, the switching unit switches the first mode to the second mode and the controller reduces the amount of light emission of the indicator.

11. The information processing device according to claim 8, wherein when the first mode is switched to the second mode, the switching unit selects two of the at least three photosensors that correspond to the detected position coordinates of the indicator, as the two of the at least three photosensors used in the second mode.

12. The information processing device according to claim 11, wherein in the second mode, the two photosensors that correspond to the detected position coordinates of the indicator are first and second closest to the position coordinates of the indicator.

13. The information processing device according to claim 12, wherein in the second mode, the first and second closest to the position coordinates of the indicator are other than one of the at least three photosensors that is positioned within prescribed distance from the position coordinates of the indicator.

14. The information processing device according to claim 8, wherein in the second mode, the detector turns off a power of at least one of the photosensors that is not used for detecting the position coordinates of the indicator.

15. A computer-readable non-transitory recording medium storing a program for causing a computer to execute a method, the method comprising:
detecting position coordinates of an indicator that emits an optical signal on a board, based on the optical signal received from the indicator;
switching between a first mode in which the position coordinates of the indicator are detected based on the optical signal received by at least three photosensors arranged on a periphery of the board and a second mode in which the position coordinates of the indicator are detected based on the optical signal received by two of the at least three photosensors; and
controlling an amount of light emission of the indicator according to the first or second mode switched by the switching.
